(19) United States
(12) Patent Application Publication
(10) Pub. No.: US 2009/0159421 A1
(43) Pub. Date: Jun. 25, 2009

(54) Portable closed circuit, sealed, pressurized distillation system

(76) Inventor: Chip Aadland, Scottsdale, AZ (US)

Correspondence Address: TOD R NISSLE, PO BOX 55630, PHOENIX, AZ, 85078, US

(21) Appl. No.: 12/004,571

(22) Filed: Dec. 21, 2007

(51) Int. Cl. C02F 1/04

(52) U.S. Cl. 203/11

(57) ABSTRACT

A method to produce distilled water includes the step of providing a closed-circuit, sealed, pressurized distillation unit. The unit includes a first sealed reservoir to receive and hold distilled water and removably sealingly installed in the distillation unit; a second sealed reservoir to hold contaminated water and removably sealingly installed in the distillation unit; an airstone positioned in the second reservoir to produce at least thousands of tiny bubbles per minute in contaminated water in the second reservoir; a coil positioned above the first reservoir; a cooling system operable to cool the coil; a vacuum pump with an input and an output; and conduit interconnecting the first and second reservoirs. The pump is operated to draw water vapor through a portion of the conduit and from the second reservoir into the first reservoir and into the coil to be condensed, and, to direct air from the first reservoir through another portion of the conduit into the air stone to produce at least thousands of tiny bubbles per minute in contaminated water in the second reservoir.

The invention relates to distillation systems.

More particularly, the invention relates to a water distillation system that can be utilized on a commercial scale or that can be readily incorporated in a portable unit for use in residences or remote locations.

Existing water distillation systems often require heat, multiple pumps, and expensive equipment. Although such water distillation systems have long existed, there does not appear to be market pressure to change the design of such apparatus, nor does there appear to be any recognition of a design need that would fuel a search for a change in design of such apparatus. The market trend appear to be in favor of retaining prior art apparatus. It is anticipated that references addressing priordistillation systems will indicate a general trend in favor of retaining prior art apparatus, and, at a minimum, will not set forth a trend toward distillation apparatus of the type utilized in the invention described herein. Since the knowledge of a skilled artisan in the pertinent art is reflected in such prior distillation systems, there does not seem to be motivation for the artisan to consider altering such apparatus in accordance with the invention.

The distillation system of the invention utilizes a previously unidentified combination and process which provide functions that are unanticipated and unpredictable in view of the prior art.

Therefore, it is a principal object of the instant invention to provide an improved distillation system.

This and other, further and more specific objects and advantages of the invention will be apparent to those skilled in the art from the following detailed description thereof and from the drawings, in which:

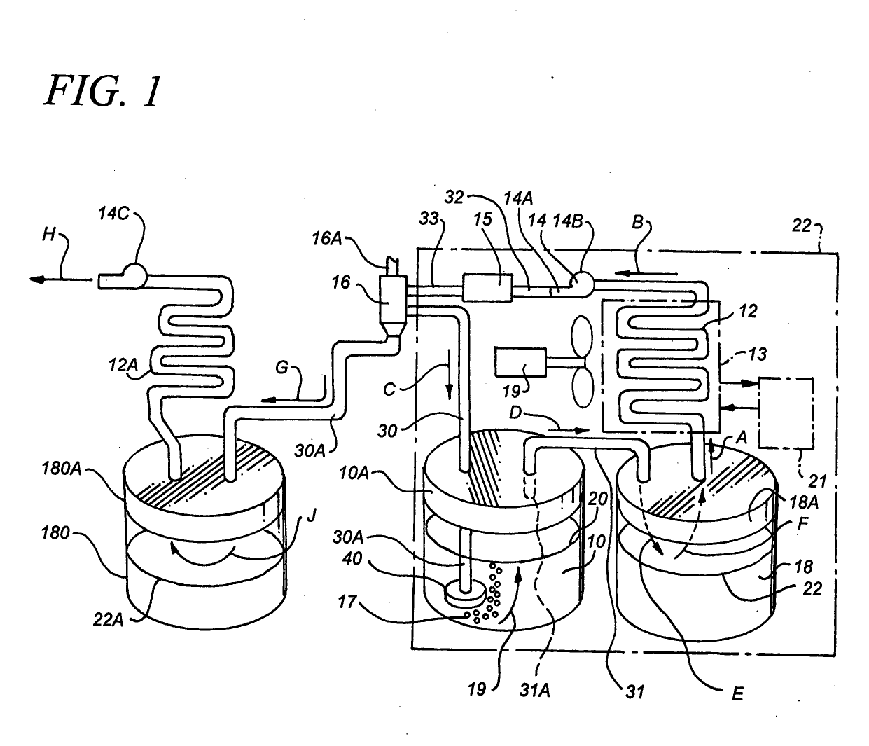

FIG. 1 is a diagram illustrating a distillation unit constructed in accordance with the invention.

Briefly, in accordance with the invention, I provide an improved method to produce distilled water. The method includes the step of providing a closed-circuit, sealed, pressurized distillation unit. The distillation unit includes a first sealed reservoir to receive and hold distilled water and removably sealingly installed in the distillation unit; a second sealed reservoir to hold contaminated water and removably sealingly installed in the distillation unit; a coil positioned above the first reservoir; a cooling system operable to cool the coil; a vacuum pump with an input and an output; and, conduit interconnecting the first and second reservoirs, the coil, and the vacuum pump such that when the pump is operated the input of the pump creates low pressure in the first and second sealed reservoirs, draws water vapor from the second reservoir into the first reservoir and into the coil to be condensed and flow downwardly under gravity into the first reservoir, and such that the output of the pump forces gas into the contaminated water to bubble upwardly through the water to facilitate saturation of air in the second reservoir with water vapor. The method also includes the steps of removing the first reservoir from the distillation unit; filling the first reservoir with contaminated water; sealingly installing the first reservoir in the distillation unit; operating the cooling system to cool the coil; and, operating the pump to draw water vapor from the second reservoir into the first reservoir and the coil to be condensed, and, to bubble gas upwardly through contaminated water in the second reservoir.

Turning now to the drawings, which illustrate the presently preferred embodiments of the invention, and in which like reference characters correspond to similar elements throughout the several views, FIG. 1 illustrates a distillation unit constructed in accordance with the invention and including a housing 22. Mounted within housing 22 are a first reservoir or container 18, a second reservoir or container 10, a vacuum pump 14, a coil 12, a filter 15, a three-way bleed valve 16, and a fan 19. Conduit 32 interconnects pump 14 and filter 15. Conduit 33 interconnects filter 15 and valve 16. Conduit 30 interconnects valve 16 and container 10. Conduit 31 interconnects containers 10 and 18. Container 10 includes a threaded top, or lip (not visible), that removably sealingly turns into lid 10A. Container 18 includes a threaded top, or lip (not visible), that removably sealingly turns into lid 18A. Container 10 is removed from lid 10A to fill container 10 with salt water 20 or other contaminated water that is to be distilled. Container 18 is removed from lid 18 when container 18 includes a desired amount of distilled water 22. Container 10 can, if desired, be designed such that it can be charged (via a valve, etc.) with contaminated water or other liquids without having to remove container 10 from the distillation unit. Container 18 can, if desired, be designed such that distilled water can be removed (via a valve, etc.) from container 10 without having to remove container 10 from the distillation unit.

Power to operate pump 14 or fan 19 can be provided by any desired conventional power source. Typically, however, the distillation unit of FIG. 1 includes batteries that power pump 14 or fan 19, and/or, includes an electrical cord that can be plugged into a conventional 120 V electrical wall outlet. Of course, pump 14 or fan 19 can be powered by a gasoline motor or any other kind of power source.

Fan 19 is utilized to cool condensation coil 12. If desired, coil 12 can be housed in a container 13 of cold water or another cooled fluid. A refrigeration unit 21 can be provided to cool water in container 13. If the ambient air is sufficiently cool, fan 19 can direct ambient air over coil 12 to cool coil 12.

Filter 15 can be utilized to remove any residual contaminants from gas theat exits pump 14 through outlet 14A after being drawn into pump 14 through inlet 14B.

The path of travel of gas and liquid through conduits in the distillation unit of FIG. 1 is indicated by arrows A to F.

Valve 16 is normally closed so that gas travels from filer 15 through valve 16 and to reservoir 10. Valve 16 can, however, be opened to bleed air and water (or other liquids or gases) from the closed circuit of the distillation unit. Valve 16 is initially positioned to bleed air outwardly through vent 16A into the ambient air when vacuum pump 14 is initially being operated to produce a desired vacuum in the system. The desired vacuum is preferably in the range of ten to twenty-five inches of mercury. Since there is no such thing as a perfect vacuum, there is always some residual air in the closed, sealed distillation system of the invention.

Valve 16 can be positioned to direct all flow through conduit 30 in the direct of arrow C, can be positioned to direct a portion of the air flow through conduit 30 and a portion through conduit 30A, or can be positioned to direct all flow through conduit 30A. When residual air/water vapor travels through conduit 30A in the direction of arrow G, it flows into container 180 and into coil 12A in the manner indicated by arrow J. Coil 12A cools the residual air/water vapor to condense water that flows downwardly through coil 12A into container 180 and into water 22A. An auxiliary cooling system comparable to fan 19 or container 13 can be utilized to cool coil 12A. An auxiliary fan or pump 14C can be utilized to draw air/water vapor through coil 12A and out into the ambient air in the manner indicated by arrow H.

In use, reservoir 10 is removed from the distillation unit, is filled with salt water, and is re-installed in the distillation unit by sealingly threading the top lip of reservoir 10 back into lid 10A. Fan 19 is operated to blow air over and cool coil 12. Vacuum pump 14 is operated. Pump 14 creates a vacuum, or at least a partial vacuum or low pressure, in coil 12, inside reservoir 18, in conduit 31, and inside reservoir 10 such that air in reservoir 10 becomes saturated with water vapor, is drawn in the direction of arrow D through conduit 31 into reservoir 18 in the manner indicated by arrow E, and is then drawn upwardly in the direction of arrows F and A into coil 12. When the water saturated air entering coil 12 is cooled, water condenses and flows downwardly under gravity through coil 12 back into reservoir 18 to accumulate as distilled water 18. Air which passes completely through coil 12 travels in the direction of arrow B into the inlet 14B of pump 14 and then exits pump 14 through outlet 14A and travels through filter 15 and valve 16 into conduit 30. The air travels through conduit 30 in the direction of arrow C and exits end 30A through air stone 40 to produce tiny bubbles that rise up to the surface of water 20 in the manner indicated by arrow 19. End 30A and air stone 40 are preferably, although not necessarily, located completely beneath the upper surface of contaminated water 20. The air traveling through conduit 30 travels through end 30A into and through porous air stone 17 to produce at least thousands of tiny bubbles per minute that travel upwardly through the water 20 in the direction indicated by arrow 19. The bubbles are an important feature of the invention because even though the air tends to reduce the vacuum produced in reservoir 10, the bubbles disrupt the surface tension of water in reservoir 10 and facilitate the incorporation of water vapor in air in reservoir 10 and reduces or eliminates the necessity of utilizing heat to drive off water vapor into the air in reservoir 10.

The tiny bubbles produced by airstone 40 each have a diameter that is less than four mm, preferably less than two mm, and most preferably less than one mm.

As used herein, the term airstone describes an actual airstone or other apparatus that provides the equivalent function of producing at least thousands of bubbles per minutes of tiny bubbles in water 20. An airstone is a porous piece of material, typically limewood or porous stone, that diffuses oxygen into water by producing many tiny air bubbles. Airstones are increasingly being made from bonded glass beads and from synthetic materials like fiberglass. Airstones ordinarily are used to aerate fish tanks and ponds, but not in conjunction with vacuum and distillation systems.

A system can be provided to continuously automatically fill container 10 with contaminated water to maintain a desired water level in container 10. Similar, a system can be provided to remove distilled water from container 18 when the water level in container 18 reaches a predetermined level. Systems for adding and removing water from ponds and other water reservoirs are well known.

One particular advantage of the distillation system of the invention is that although container 10 can, if desired, be heated, the system does not require the utilization of supplemental heat. The system typically is operated in ambient air and the water added to container 10 ordinarily is not heated, although such water can, if desired, be heated.

Having described my invention in such terms as to enable those skilled in the art to understand and practice it, and having described the presently preferred embodiments thereof, I Claim:

1. A method to produce distilled water, comprising the steps of
(a) providing a closed-circuit, sealed, pressurized distillation unit including
(i) a first sealed reservoir to receive and hold distilled water and removably sealingly installed in said distillation unit,
(ii) a second sealed reservoir to hold contaminated water and removably sealingly installed in said distillation unit,
(iii) an airstone positioned in said second reservoir to produce at least thousands of tiny bubbles per minute in contaminated water in said second reservoir,
(iii) a coil positioned above said first reservoir,
(iv) a cooling system operable to cool said coil,
(v) a vacuum pump with an input and an output, and
(vi) conduit interconnecting said first and second reservoirs, said coil, and said vacuum pump such that when said pump is operated,
said input of said pump
creates low pressure in said first and second sealed reservoirs,
draws water vapor from said second reservoir into said first reservoir and into said coil to be condensed and flow downwardly under gravity into said first reservoir, and
said output of said pump
forces gas into said contaminated water to bubble upwardly through said water to facilitate saturation of air in said second reservoir with water vapor;
(b) filling said first reservoir with contaminated water to at least partially cover said air stone;
(c) operating said cooling system to cool said coil; and
(d) operating said pump to draw water vapor through a portion of said conduit and from said second reservoir into said first reservoir and into said coil to be condensed, and, to direct air from said first reservoir through another portion of said conduit into said air stone to produce at least thousands of tiny bubbles per minute in contaminated water in said second reservoir.
